(19) United States
(12) Patent Application Publication
(10) Pub. No.: US 2024/0016698 A1
(43) Pub. Date: Jan. 18, 2024

(54) SUSPENDED INTRAVASCULAR FLUID BAG PRESSURIZING APPARATUS AND METHODS OF USE

(71) Applicant: David P Stonko, Manchester, MD (US)

(72) Inventor: David P Stonko, Manchester, MD (US)

(21) Appl. No.: 18/036,761

(22) PCT Filed: Oct. 26, 2022
(86) PCT No.: PCT/US2022/047795

§ 371 Date: May 12, 2023

Related U.S. Application Data
(60) Provisional application No. 63/273,083, filed on Oct. 28, 2021.

(51) Int. Cl. A61J 1/12; A61J 1/14

(52) U.S. Cl. CPC A61J 1/12; A61J 1/1493; A61J 2200/76

(57) ABSTRACT

Apparatus and method for pressurization of fluid and delivery of fluid under pressure from a suspended or non-suspended fluid bag into blood vessels are disclosed. The fluid bag apparatus may include a securing device for securing the fluid bag to a holding device. The shape of the securing device may conform to the holding device and may support rolling up an emptying, collapsed or flattened fluid bag around a cylindrically shaped holding device. The holding device may engage with a pressurizing system. The pressurizing system may rotate the holding device prior to or after securing a fluid bag. An engaged pressurizing system may also prevent or control the unraveling of the rolled-up fluid bag. A release device or the motor device may release the engaged pressurizing system to unwind for unraveling and removal of the flattened fluid bag.

### CROSS-REFERENCE TO RELATED APPLICATION

This application claims the benefit of Provisional Patent Application No. 63/273,083, filed on Oct. 28, 2021.

### BACKGROUND OF THE INVENTION

A hypotensive patient, that is, a patient experiencing low blood pressure from, for example, bleeding or sepsis, may require an immediate infusion of fluid or blood. In a planned, calm surgical environment, bags of blood or intravenous (“IV”) fluid may be hung from a pole. A combination of gravity, atmospheric pressure, and fluid mechanics may push and pull the fluid from a fluid bag through an infusion tube and into an IV tube for delivery to the patient. Accordingly, suspended fluid bags may deliver fluid in a non-emergency environment.

In an emergency, a medical professional may want to increase the rate of fluid delivered to a patient, such as a human or veterinary patient. Pressure may be applied to an exterior surface of a blood or IV bag, hereinafter referred to collectively as a fluid bag, to increase the flow rate of fluid delivery to the patient. As fluid exits a fluid bag, the pressure inside the bag decreases. Maintaining a high flow rate of the fluid from the fluid bag to the patient, while avoiding a reverse fluid flow from the patient to the fluid bag, may require fluid pressure adjustments. The fluid pressure adjustments may accommodate a decrease in pressure as fluid exits the fluid bag. Alternatively, medical professionals may pressurize fluids connected to the inside of arteries (IA) of a patient via infusion tubing. In this case, a medical professional may measure pressure in an artery, rather than infuse fluids into the patient. A pressurized fluid bag may be pressurized to at least the level of the patient's blood pressure so that the blood pressure can be monitored. Accordingly, pressure may be applied to a fluid bag as fluid leaves the fluid bag.

Pressure applied to an exterior surface of a fluid bag may increase pressure on fluid in a fluid bag. However, applying pressure to an external surface of a fluid bag may require medical professional time, which may be in limited supply in an emergency. Further, medical professionals may question volume readings associated with remaining fluid in a fluid bag when pressure applied to a fluid bag exterior surface deforms the fluid bag shape. Pressure to the external surface of a fluid bag may modify a level of a fluid or obscure a volume ruler imprinted on the exterior surface of the fluid bag. Exterior compression to the fluid bag may also obscure the appearance of labels or information written or printed on the fluid bag, such as blood type or medication instructions. Further, some fluid bags may contain air in addition to fluid, or air may be introduced before the fluid is being delivered to the patient. Air should not generally be delivered to a patient. A fluid bag may be kept upright, so a fluid delivery device will not deliver air. Accordingly, medical professionals may face obstacles delivering a desired amount of blood or other IV fluid to either a human or veterinary patient.

### SUMMARY OF THE PRESENT INVENTION

Various exemplary embodiments of the present disclosure may demonstrate one or more of the invention features. Other features and advantages of this invention will become apparent from the following detailed description of the presently preferred embodiments of the invention, taken in conjunction with the accompanying drawings.

In accordance with an exemplary embodiment, an intravenous fluid bag apparatus includes a fluid bag holding device in communication with a fluid bag securing device. The apparatus further includes a fluid bag guiding device and a holding device release device. The apparatus further includes a pressurizing device in communication with the holding device.

In accordance with another exemplary embodiment, a method of delivering fluid from an intravenous fluid bag includes securing a fluid bag to a holding device in a first position and rolling the secured fluid bag around the holding device to a second position. The method further includes increasing pressure on fluids in the fluid bag at the second position and delivering fluids from the secured fluid bag. The method further includes releasing the holding device from the second position and releasing the secured fluid bag from the holding device.

In accordance with a further exemplary embodiment, a method of pressurizing fluid in an intravenous fluid bag includes rotating an empty holding device in communication with a tension-creating device to a first position, the tension-creating device absorbing energy from the rotating to the first position. The method further includes securing a fluid bag to the holding device and releasing the tension-creating device. In doing so, the method further includes using energy from the tension-creating device to rotate the holding device securing the fluid bag. The method further includes maintaining pressure on fluids in the secured fluid bag while further releasing energy from the tension-creating device.

It is to be understood that both the foregoing general description and the following detailed description are exemplary and explanatory only and are not restrictive of the present disclosure or claims.

### BRIEF DESCRIPTION OF THE DRAWINGS

The drawings referenced herein are incorporated in and form part of the specification. The drawings illustrate one or more exemplary embodiments of the present disclosure and together with the description serve to explain various principles and operations. Implications that the drawings illustrate all embodiments of the invention are not to be made.

FIG. 1 illustrates a front-perspective of a suspended fluid bag set-up, as is well understood in the art.

FIGS. 2A and 2B illustrate a front perspective view of an exemplary embodiment of an intravascular fluid bag pressurizing apparatus in accordance with the present disclosure.

FIG. 3 illustrates a top-front perspective view of an exemplary embodiment of a fluid bag securing device in accordance with the present disclosure.

FIG. 4 illustrates a top-front perspective view of an exemplary embodiment of a ratcheting system in accordance with the present disclosure.

FIG. 5 illustrates a top-front perspective view of an exemplary embodiment of an apparatus housing in accordance with the present disclosure.

FIG. 6 illustrates a top-front perspective view of an exemplary embodiment of a deployed apparatus housing in accordance with the present disclosure.

FIG. 7 illustrates a flow diagram showing pressurizing a fluid bag in accordance with the present disclosure.

### DETAILED DESCRIPTION OF THE INVENTION

Reference will now be made in detail to various exemplary embodiments of the present disclosure, examples of which are illustrated in the accompanying drawings.

It will be readily understood that the components of the present invention, as generally described and illustrated in the figures herein, may be arranged and designed in a wide variety of different configurations. Thus, the following detailed description of the embodiments of the intravascular fluid bag pressurizing apparatus and methods of use of the present invention, as presented in the figures, is not intended to limit the scope of the invention, as claimed, but is merely representative of selected embodiments of the invention.

Reference throughout this specification to “a select embodiment,” “one embodiment,” or “an embodiment” means that a particular feature, structure, or characteristic described in connection with the embodiment is included in at least one embodiment of the present invention. Thus, appearance of the phrases “a select embodiment,” “in one embodiment,” “an exemplary embodiment” or “in an embodiment” in various places throughout this specification are not necessarily referring to the same embodiment.

Features, structure, or characteristics described herein may be combined in any suitable manner in one or more embodiments. One skilled in the relevant art will recognize, however, that the invention may be practiced without one or more of the specific details, or with other methods, components, or materials. In other instances, well-known materials or processes are not shown or described in detail to avoid obscuring aspects of the invention. The following description, which shows by way of illustration a specific embodiment in which the invention may be practiced, is intended only by way of example. That is, the following description simply illustrates certain selected embodiments of an intravascular fluid bag pressurizing apparatus and methods of use that are consistent with the invention as claimed herein. It is to be understood that other embodiments may be utilized because structural and process changes may be made without departing from the scope of the present invention.

In critically ill or injured human patients or animal patients, collectively referred to herein below as patients, blood pressure or other pressure from inside of the patient needs to be measured for clinical decision making. A common strategy for measuring these pressures may involve inserting a cannula or other probe into the patient's body compartment, such as their arterial system or venous system, and connecting that cannula or probe to a monitoring device. The most common embodiment of this is an “arterial line” or “art-line” which measures the patient's arterial blood pressure. A configuration of this monitoring device may involve counter-pressurizing the patient's body compartment pressure with pressurized fluids in an intravenous (“IV”) fluid bag, herein frequently referred to as a fluid bag. Pressure may be transduced using a similar setup for other locations, such as the bladder, the venous system, or the central nervous system. Other situations where pressure inside a patient may be transduced are considered herein. By pressurizing the system in this way, the monitor or probe may directly sense a patient's blood pressure, or other pressure of interest. In these circumstances, pressurized fluids are required, but they are not actually delivered to the patient, or are delivered at very slow rates. These monitoring devices require the fluid to be held at a constant pressure over time—and the constant pressure value acts as a reference point for the monitoring systems. However, some currently available strategies for pressurizing IV fluids are lacking because, over long periods of time, the pressurization may wane. Accordingly, traditional approaches to maintain a patient's body compartment pressure with pressurized fluids may be unreliable.

Pressure applied to an exterior surface of a fluid bag may increase pressure on fluid in a fluid bag. However, applying pressure to an external surface of a fluid bag may require medical professional time, which may be in limited supply in an emergency. Further, medical professionals may question volume readings associated with remaining fluid in a fluid bag when pressure applied to a fluid bag exterior surface deforms the fluid bag shape, modifies the level of the fluid meniscus, or obscures a volume ruler imprinted on the exterior surface of the fluid bag. Accordingly, medical professionals may face obstacles delivering a desired amount of blood or other IV fluid to a patient.

When pressurized fluids are delivered from a fluid bag, invariably the fluid will run out in most circumstances. If the patient is critically ill or injured, the rapidity at which a new full fluid bag can replace the empty fluid bag is paramount. If a pneumatic system is used to pressurize and then displace IV fluid as it is delivered, the air added to the pneumatic system when the fluid is being delivered must necessarily be removed in order to replace the now empty fluid bag with a new, full fluid bag. Then, to pressurize the new full fluid bag, new air must be added to the pneumatic compression system to pressurize the new fluid bag. Adding new air requires time. Pneumatic compression systems also work by displacing fluid along the entire length of the fluid bag. However, fluid bags of different volumes (e.g., 200 cc, 250 cc, 500 cc, 1000 cc) have different lengths (where length is the measure from the top of the fluid bag to the bottom of the fluid bag when it is suspended from an IV pole). This means that each sized fluid bag tends to be associated with a specific sized pneumatic compression device for pressurizing IV fluids. Rather than run along the length of a fluid bag, a device that runs along the width of the bag, which tends to be similar between various volumed fluid bags, would be helpful. One sized device may interchangeably pressurize multiple sized IV fluid bags. Further, pneumatic compression or automatic compression also have little to no haptic or auditory feedback to indicate how much pressurize is applied or how much fluid is being delivered to a clinical user. Accordingly, users may face obstacles with pneumatic compression systems.

Medical professionals in an emergency may be challenged with quickly delivering fluid to hypotensive patients. A fluid bag may be suspended from a pole to encourage rapid fluid flow. The fluid bag may comprise fluid, such as blood, saline, or water, for delivery to a patient. Fluid may also comprise, for example, intra-arterial fluid, or fluid for dialysis or burn treatment. A combination of, at least, gravitational force and atmospheric pressure may encourage flow of the fluid through and out an exit point, or solution port, in the fluid bag, and to a patient via an infusion tube. Further, a medical professional may deliver fluid from the tube to the patient via an IV tube: at the point where the IV tube interfaces with, for example, the patient's venous system, fluid flow mechanics may draw fluid from the fluid bag and deliver the fluid to the patient via the IV tube. A caliber of the IV tube may determine the speed at which fluid flows to the patient from the fluid bag. A combination of gravity, atmospheric pressure, and fluid flow mechanics at the IV tube may overcome the back pressure at the solution port for delivery of the fluid to the patient. Accordingly, a combination of gravitational force, atmospheric pressure and fluid mechanics may encourage delivery of fluid from a suspended fluid bag to a patient.

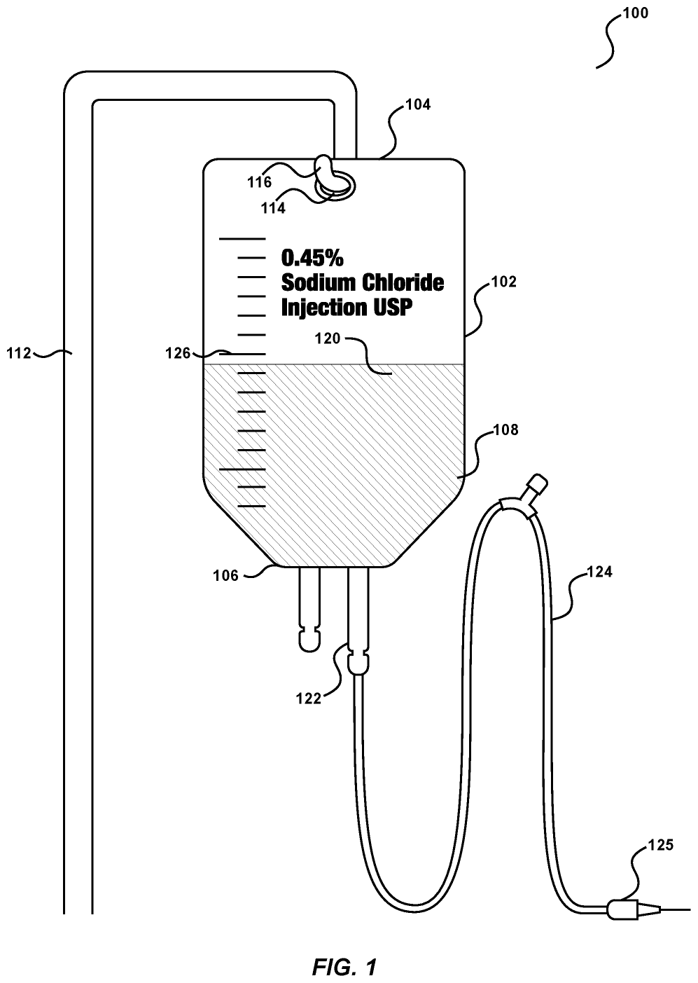

A person of ordinary skill in the art may suspend a fluid bag from a pole or other device from which normally a fluid bag would be suspended. FIG. 1 illustrates a front-perspective of a suspended fluid bag set-up (100), as is well understood in the art. The fluid bag set-up (100) may comprise a fluid bag (102), which may comprise a top (104), a bottom (106), a front face (108), and a back face (not shown). In an example, the fluid bag (102) may comprise a plastic material. As may be understood in the art, a medical professional may suspend the fluid bag (102) on a pole (112) by placing a hole (114), positioned in the fluid bag (102) near the top (104), on a hook (116) on the pole (112). Accordingly, a fluid bag may suspend from a pole.

A fluid bag (102) may comprise a pliable bag and may contain fluid (120), such as a low viscosity fluid, such as blood or IV fluid. It is well understood in the art that gravity may act on the fluid (120) in the suspended fluid bag (102). It is well understood in the art that the contents of the suspended fluid bag (102) may comprise air, in addition to a desired fluid. A substantially vertical orientation of the suspended fluid bag (102) may support delivery of fluid, rather than air, to a patient. Indeed, the suspended fluid bag (102), by virtue of its vertical suspension and the relative densities of air and fluid, may encourage preferential delivery of fluid to a patient. Under atmospheric pressure and gravitational forces, the fluid (120) may flow downward from the top (104) to the bottom (106) of the fluid bag (102). A nozzle or solution port (122) may be positioned near the bottom (106) of the fluid bag (102). A medical professional may, for example, connect infusion tubing (124) to the solution port (122). The fluid (120) may flow from the top (104) to the bottom (106) of the fluid bag (102), out through the solution port (122), and through the infusion tubing (124) to, for example, a patient's venous system via an intravenous needle (125). Accordingly, as is well understood in the art, medical professionals may suspend a fluid bag on a pole and fluid may flow downward through the fluid bag for delivery to a patient.

A medical professional may monitor a volume of fluid (120) remaining in a fluid bag (102) as the fluid (120) exits through a solution port (122). For example, a ruler (126) may be stamped on a front face (108) of the fluid bag (102) and a medical professional may view the ruler (126) to regulate the volume of fluid (120) remaining in the fluid bag (102). In this way, a medical professional may identify the volume of both the fluid delivered to a patient and the fluid remaining in the fluid bag. Accordingly, a medical professional may monitor the volume of fluid delivered to a patient.

Because a patient's arterial blood pressure is higher than the pressure of the tubing filled with fluid when it is not pressurized, a medical professional may choose to place fluid (120) in a suspended fluid bag (102) under pressure to avoid blood flowing from the patient to the fluid bag. The fluid bag (102) may be connected to tubing (124) and deliver fluid (120) under pressure from the fluid bag (120) and into a patient's venous system or arterial system. The fluid bag (102) may alternatively act as fluid conduit between the venous system or arterial system and a connected pressure monitoring device. The pressure monitoring device, which may “sit” on the tubing (124) may transduce pressure measurements from this fluid bag and thereby measure the pressure. For example, pressure may be transduced via tubing (124) between a fluid bag (102) and a patient, which may equalize the pressure between the fluid bag (102) and the patient. Indeed, medical professionals in an emergency may place the fluid (120) in a fluid bag (102) under pressure to increase the rate of delivery of the fluid (120) to the patient. Medical professionals may apply pressure to the fluid bag (102), or, more specifically, to the front face (108) and back face (not shown), or, for example, circumferentially. For example, a medical professional may manually squeeze a fluid bag (102), such as the front face (108) and back face (not shown). By squeezing the fluid bag (102), the medical professional may increase pressure on fluid (120) remaining in the fluid bag (102) as fluid (120) exits the fluid bag (102). In another example, an inflatable device may press on the external surface, such as the front face (108) and back face (not shown) of a fluid bag (102). Accordingly, pressure applied to an exterior face of a fluid bag, in addition to gravitational forces, atmospheric pressure and fluid mechanics, may encourage rapid delivery of fluid from a suspended fluid bag to a patient.

However, the inflatable device may require a medical professional to monitor the pressure within the inflatable device. Keeping the inflatable device inflated may require inflating the inflatable device as fluid leaves the fluid bag multiple times until the fluid bag empties. Further, in as suspended configuration, the inflatable device may require re-hanging the fluid bag when the inflatable device deflates. Also, the ruler (126) may become unusable as the inflatable device may mask and obscure the ruler (126) or deform the fluid bag's shape thereby distorting the fluid meniscus within the fluid bag and making the fluid appear more voluminous than it really is. To that end, a medical professional may spend time applying pressure to a fluid bag or adjusting an inflatable device to place fluid in a fluid bag under pressure. Accordingly, medical professionals in an emergency may face obstacles to rapid delivery of fluid to a patient especially as numerous related and unrelated multitasking must be accomplished.

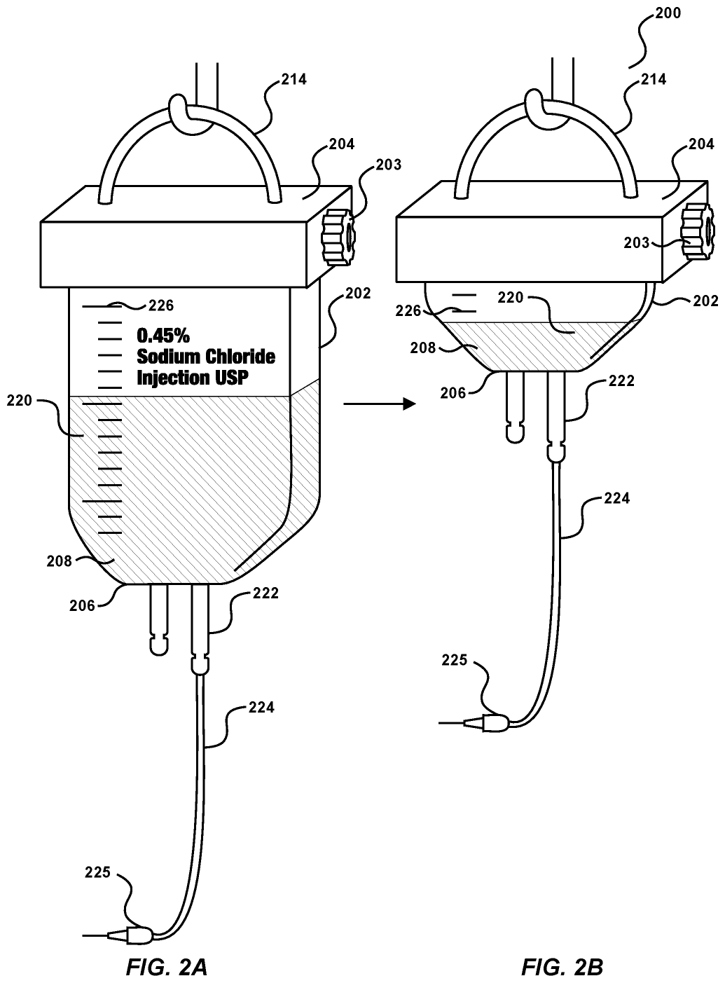

An intravascular fluid bag pressurizing apparatus and method of use of the present invention may address these issues. FIGS. 2A and 2B illustrate a front perspective view of an exemplary embodiment of a intravascular fluid bag pressurizing apparatus (200) in accordance with the present disclosure. It is to be understood that elements of the present invention may support a suspended or non-suspended intravascular fluid bag pressurizing apparatus. That is, embodiments of the present invention may function effectively on fluid bags, which are laid flat, such as de-aired bags, or in zero gravity situations. Accordingly, for ease of explanation, the present disclosure may provide embodiments for suspended intravascular fluid bags.

An intravascular fluid bag pressurizing apparatus (200) may use a combination of a securing device and holding device within a housing (204) to secure the top (not shown) of the fluid bag (202) to the holding device. In an embodiment, for example, an intravascular fluid bag pressurizing apparatus (200) may comprise a fluid bag (202) comprising a volume of fluid (220), such as bio-compatible appropriate material, or other non-toxic materials, as measured by a ruler (226) on a front face (208) of the fluid bag (202). In an embodiment, a holding device (not shown) may comprise, for example, a cylindrical or approximately cylindrical bar. As shown in FIG. 2A, a fluid bag (202) comprising a volume of fluid (220) may extend from a housing (204). Within the housing (204) as the holding device rotates, the top of the secured fluid bag necessarily rotates with the holding device. As shown in FIG. 2B, as the top of the secured fluid bag (202) is emptied of fluid (220) and therefore substantially collapsed or flattened, the fluid bag (202) may roll up around the holding device. Accordingly, a suspended or non-suspended secured fluid bag may roll up around a holding device of the present invention and may pull up the secured fluid bag.

The top of the fluid bag may empty, as fluid (220) leaves the fluid bag (202) via infusion tubing (224) or via a solution port (222). The fluid (220) may flow from the top (not shown) to the bottom (206) of the fluid bag (202), out through the solution port (222), and through the infusion tubing (224) to, for example, a patient's venous system via an intravenous needle (225). As the fluid bag empties, the top portion may deflate, and the interior faces of the fluid bag may collapse toward each other, so the fluid bag may flatten. In a substantially flattened state, the empty portion of the fluid bag may roll up on itself as the holding device rotates. An intravascular fluid bag pressurizing apparatus (200) of the present invention may maintain pressure on the fluid in the fluid bag by rotating the holding device and secured fluid bag at a rate complimentary to the flow of fluid from the fluid bag, and until the fluid bag empties. Accordingly, an intravascular fluid bag pressurizing apparatus of the present disclosure may roll up a fluid bag and put pressure on a first volume of fluid remaining within a fluid bag while a second volume of fluid exits the fluid bag.

In a suspended embodiment of the present invention, an intravascular fluid bag pressurizing apparatus (200) may support suspending a fluid bag while, concurrently, pressurizing fluid in the fluid bag to allow the fluid to rapidly flow from the fluid bag for delivery to a patient. A full fluid bag (202) may comprise a solution port (208) and, for example, may be secured in a housing (204). The intravascular fluid bag pressurizing apparatus (200) may comprise the housing (204), a fluid bag securing device (not shown), a ratcheting device (not shown) and a hanging device (214) for hanging the suspended intravascular fluid bag pressurizing apparatus (200) on, for example, a pole. In an exemplary embodiment, as fluid, such as blood, saline, or intravenous fluid, contained within the fluid bag (202) leave the fluid bag (202), the combination of elements of the intravascular fluid bag pressurizing apparatus (200) may maintain pressure on the fluid within the fluid bag (202). By maintaining pressure on the fluid within the fluid bag (202), the fluid may be encouraged to flow from the fluid bag (202) through a solution port (208) for delivery to a patient under pressure. Accordingly, an intravascular fluid bag pressurizing apparatus of the present invention may secure a fluid bag in a suspended position.

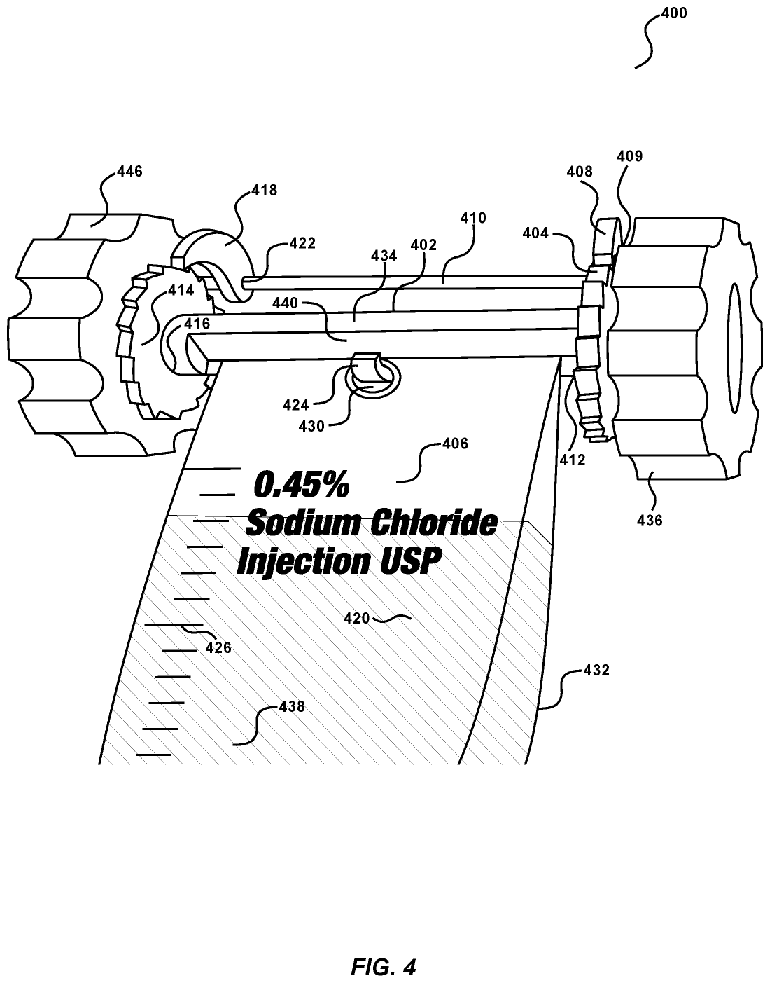

An intravascular fluid bag pressurizing apparatus (200) may include a holding device comprising at least one knob (203) to facilitate rotating the holding device, which may hold a fluid bag (202) within a housing (204). An intravascular fluid bag pressurizing apparatus (200) may also include a pressurizing system, such as a motor device, rubber band, or other pressurizing system. In an exemplary embodiment, the pressurizing system may comprise a ratcheting system as described herein below in FIG. 4. Turning the knob (203), for example, may engage the pressurizing system, such as a ratcheting system, so the holding device stops rotating and does not turn backward. The fluid bag (202) may suspend initially in a position shown in FIG. 2A and may subsequently suspend in a second position, as shown in FIG. 2B. The ratcheting system may also prevent undesired unraveling of the rolled-up fluid bag. Accordingly, a ratcheting system of the present invention may control rotation of a holding device.

In an exemplary embodiment, the ratchet system may provide haptic feedback. That is, a user using an intravascular fluid bag pressurizing apparatus (200) of the present invention may find it difficult to turn the knob (203) as fluid (220) leaves a fluid bag (202). Indeed, the difficulty in turning the knob (203) may correlate with how much pressure is in the fluid bag (202). To that end, in an exemplary embodiment, the rotating and tensioning of the knob (203) means the bag cannot be over pressurized. Further, a provider of intravascular fluid (220) may estimate how much fluid (220) to fill a fluid bag (202) based on how taught the knob (203) feels. Further, clicking generated by the ratchet as it turns may also provide auditory feedback. Accordingly, a knob of the present invention may provide feedback to a user.

An intravascular fluid bag pressurizing apparatus (200) may engage the knob (203), holding device, and ratcheting system to roll up a fluid bag (202) and, thereby, exert pressure on fluid (220) in the fluid bag (202) as the fluid bag (202) empties. Accordingly, a fluid bag may roll-up around a holding device of the present invention and apply pressure to fluid in the fluid bag.

As described herein above, an intravascular fluid bag pressurizing apparatus (200), as described in FIGS. 2A and 2B, may comprise multiple elements. For example, in an embodiment, an intravascular fluid bag pressurizing apparatus (200) of the present invention may comprise a securing device for securing the top of a fluid bag (202) across a holding device within a housing (204). In an embodiment, for example, this combination of securing device and holding device elements may function to suspend the fluid bag (202) from within the housing (204). The holding device may direct the bag to flatten as it winds around, for example, a rotating cross bar. A combination of securing device, holding device, and housing (204) of the present invention may facilitate replacing a fluid bag with another fluid bag. Further, a securing device may clamp or unclamp with ease to facilitate the fluid bag replacing process. Indeed, a securing device of the present invention may accommodate multiple sizes of fluid bags. Accordingly, elements of the present invention may facilitate fluid bag securing and removing.

Further, by virtue of the fluid bag (202) have a greater length than the housing (204), in an embodiment of the present invention, an intravascular fluid bag pressurizing apparatus (200) may avoid obscuring a fluid meniscus within the fluid bag (202). To that end, a provider may easily and accurately tell how much fluid remains in the fluid bag (202). Further, an intravascular fluid bag pressurizing apparatus (200) of the present invention may leave the medication label on the fluid bag or blood fully in view. This visibility supports patient safety as events have been reported where doctors or nurses thought they were receiving one type of fluid, such as type O blood, but they were receiving another type of fluid, such as type A blood. As described herein, in an embodiment of the present invention, the fluid medication label, or blood labeling, on a fluid bag (202) may remain in full view. Accordingly, an intravascular fluid bag pressurizing apparatus of the present invention may facilitate safely replacing fluid bags.

In an embodiment, an intravascular fluid bag pressurizing apparatus (200) of the present invention may further rotate the fluid bag (202) around the holding device and may pressurize the content of the fluid (220) within the fluid bag (202). A front face (208) of the fluid bag (204) may collapse and juxtapose itself onto a back face (not shown) of the fluid bag (202) as fluid (220) exits from the fluid bag (202) and pressure decreases within the fluid bag (202). The juxtaposition of the front face (208) to the back fact (not shown) may occur from the top (not shown) of the fluid bag (202) downward to the bottom (206) of the fluid bag (202), as fluid (220) leaves the fluid bag (202). Starting from the top of the fluid bag (202), rotating collapsed sections of the fluid bag (202) around the holding device may place fluid (220) within the fluid bag (202) under pressure as fluid (220) exits the fluid bag (202). As the holding device continues to rotate, the fluid bag (202) may begin to roll up onto itself, while rolling up around the holding device. Accordingly, flattened near-top portions of a fluid bag may roll-up around a holding device to apply pressure to fluid within the emptying fluid bag.

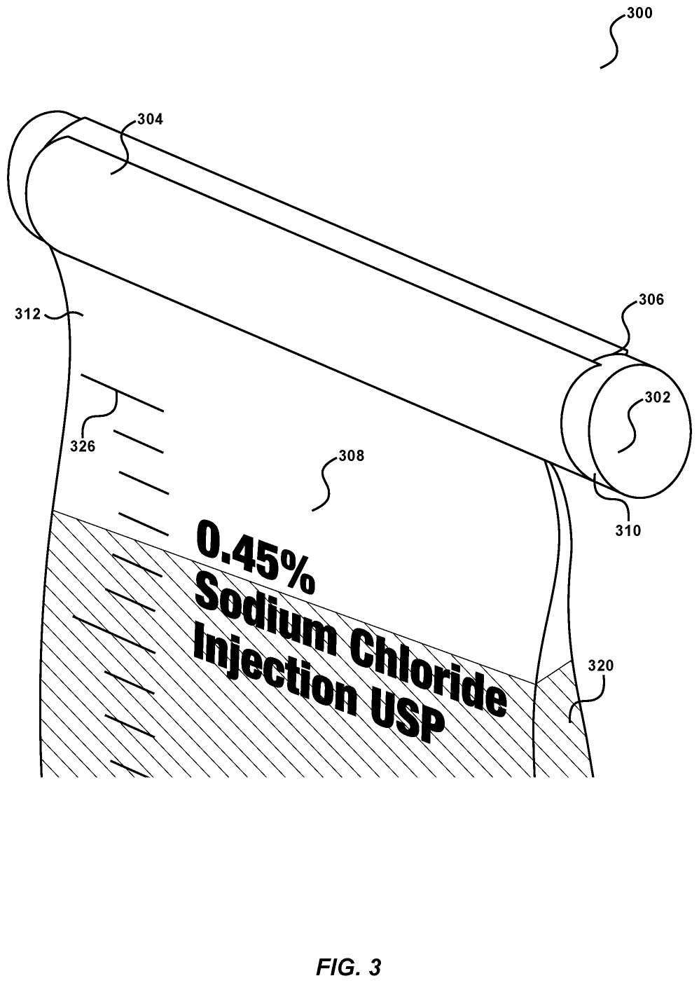

In an exemplary embodiment, a suspended intravascular fluid bag pressurizing apparatus (200), as described in FIGS. 2A and 2B, may secure a fluid bag (202), such as a blood bag or intravenous (IV) fluid bag. FIG. 3 illustrates a top-front perspective view of an exemplary embodiment of fluid bag securing device (300) in accordance with the present disclosure. A fluid bag securing device (300) of the present invention may secure a top of a fluid bag to a holding device. In an exemplary embodiment, a fluid bag securing device (300) may comprise a holding device (302), which may be referred to herein as a rotating cross bar or beam, and a clamping device (304). A holding device (302), for example, may comprise a cross bar spanning from a first side of a housing to an opposite and parallel side of the housing. In an embodiment, for example, the holding device (302) may comprise a cylindrical shape. In an exemplary embodiment, a back face (306) of a secured fluid bag (308) may communicate with an exterior surface (310) of the holding device (302): An emptying fluid bag (308), as shown in FIG. 2B, may roll up around the holding device (302) as the holding device (302) rotates. Accordingly, a fluid bag securing device of the present invention may conform a fluid bag to a rotating holding device.

In an exemplary embodiment, a clamping device (304) may secure the fluid bag (308) to the holding device (302) and may force the back face (306) of the fluid bag (308) in communication with the exterior surface (310) of the holding device (302). In an exemplary embodiment, a clamping device (304) may comprise an arm spanning across a portion of a holding device (302) and may conform to a shape of the holding device (304). In an exemplary embodiment, a clamping device (304) in an open position may receive a fluid bag (308). A clamping device (304) in a closed position may secure the fluid bag to the holding device (302). A front face (312) of a fluid bag (308), which may comprise a ruler (326) that may measure a volume of fluid (320), may communicate with an internal surface (not shown) of a clamping device (304) in a closed position. In an embodiment, a clamping device (304) may comprise a semi-cylindrical shape and, in a closed position, may conform a secured fluid bag (308) to a cylindrical shape or substantial cylindrical shape of a holding device (304). As the holding device (302) rotates, the clamping device (304) and the fluid bag (308) may conform to the cylindrical shape of the holding device (302), so the fluid bag (308) may roll up around the holding device (302). Accordingly, a secured fluid bag may conform to a shape of a holding device of the present invention while being rolled up around the holding device.

In an alternative embodiment, the clamping device (304) may comprise a series of clips, which may interface with a back face (306) of a fluid bag (308), or a combination of back face (306) and front face (not shown) of the fluid bag (308). The clamping device (304) may conform a front face (not shown) of a fluid bag (308) to an exterior surface (310) of the holding device (302). In another embodiment, the clamping device (304) may comprise a clipping mechanism, such as a hook, positioned substantially centered across a holding device (302). The clamping device (304) may be in communication with the exterior surface (310) of the holding device (304) and may communicate with a hole in a top of a fluid bag (308) or some other orifice from which the fluid bag (308) may be suspended normally. In an exemplary embodiment, as shown herein below in FIG. 4, may further comprise a cavity to capture a top edge of a secured fluid bag (308) to facilitate rolling up the fluid bag (308) around the holding device (302). Accordingly, an intravascular fluid bag pressurizing apparatus of the present invention may secure a fluid bag to a holding device.

In an exemplary embodiment, a suspended intravascular fluid bag pressurizing apparatus (200), as described in FIGS. 2A and 2B, may pressurize fluid within a fluid bag (202) as the fluid exit the fluid bag (202) via a solution port (208). In an exemplary embodiment, as described in FIG. 3, a medical professional may engage a fluid bag securing device (300) to secure a fluid bag (308) to a holding device (302) using a clamping device (304). As fluid leaves the fluid bag (308), pressure on the remaining fluid of the fluid bag may decrease. A decrease in pressure may cause blood to flow backward from the patient to the fluid bag via an infusion tube. To maintain adequate pressure on the remaining fluid in a fluid bag (308), a holding device (302) may turn and may, thereby, wrap a substantially empty portion of a secured fluid bag (308) around the holding device (302). In an exemplary embodiment, as described herein below in FIG. 4, the holding device (302) may further comprise at least one knob to facilitate rotating the holding device (302). Rotating the holding device (302) may similarly rotate the fluid bag (308) in parallel to and conformance with the exterior surface (310) of the holding device (302). As a substantially empty portion of the fluid bag (308) flattens to conform to the exterior surface (310) of the holding device (302), pressure on remaining fluid within a fluid bag (308) may increase, so fluid may leave the fluid bag (308). Accordingly, an intravascular fluid bag pressurizing apparatus of the present invention may rotate a fluid bag around a holding device of the present invention and may increase pressure on fluid remaining within the fluid bag.

In an embodiment, for example, a pressure sensor device may communicate with the fluid bag (308) to monitor fluid pressure in the fluid bag (308). In an exemplary embodiment, the pressure sensor may measure the pressure in the fluid bag (308). In another embodiment, the pressure sensor may measure a surrogate for the pressure such as torque on the holding device (302), which may correlate with the pressure within the fluid bag (308). In response to a decrease in fluid pressure, the pressure sensor device may communicate a signal to the holding device (302), the signal indicating a need to rotate to the holding device (302) to roll up an emptying fluid bag (308). In an example, the pressure sensor device may concurrently or independently communicate an alarm when the pressure on the fluid within the fluid bag (308) decreases below a set value. Accordingly, an apparatus of the present invention may measure pressure within a fluid bag and adjust holding device position to adjust the measured pressure.

In an exemplary embodiment, a ratcheting system, as described herein below in FIG. 4, may respond to a signal from a pressure sensor device, and may rotate a holding device (302) to maintain a desired pressure in the fluid bag (308). In another embodiment of the present invention, torque on the holding device (302), also known as the rotating cross beam, may be generated by some other mechanism than a ratchet system or a motor device, such as elastic bands or a pulley system. The disclosure of the present invention considers these methods of generating torque, as well. In an alternative embodiment, rotation of the holding device (302) may be limited by a captured pressure by a pressure sensing device. That is, in an embodiment, pressure on fluid within the fluid bag (308) may be limited to a set value, and a pressure sensor device may halt rotation of the holding device (302) accordingly. In an embodiment, for example, torque on a ratcheting system, as described herein below in FIG. 4, may be limited to limit pressure on fluid in the fluid bag (308) to the set value. Accordingly, a suspended intravascular fluid bag pressurizing apparatus of the present invention may monitor pressure on fluid within a fluid bag and may rotate a holding device to maintain a desired pressure on fluid remaining within the fluid bag.

In an exemplary embodiment of the present invention, rotating a fluid bag (308) around a fluid bag securing device (300) of the present invention may proceed on a step-by-step basis and may comprise a steady and irreversible process. To that end, an exemplary embodiment of a holding device (308) of the present invention may communicate with a ratcheting system. A medical professional may, for example, rotate the holding device forward, using, for example, a knob (not shown) in communication with the holding device (308). The ratcheting system may prevent the holding device from rotating backward. Accordingly, a suspended intravascular fluid bag pressurizing apparatus of the present invention may prevent a partially or substantially rolled-up fluid bag from unraveling from a holding device.

As described herein above in FIG. 3, a fluid bag securing device (300) may secure a fluid bag (308) to a holding device (302). That is, a back face (306) of the fluid bag (308) may communicate with an exterior surface (310) or interior cavity of the holding device (302). In an embodiment, the holding device (302) may comprise, for example, a cross bar with a knob positioned at an end or, for example, at both ends of the cross bar. Each knob or, for example, a key may facilitate rotating the holding device (302). Fluid pressure within a fluid bag (308) decreases as fluid (320) leaves, and the knob may help a user pressurize fluids (320) within a fluid bag (308) to facilitate fluid flow. As described herein below, pressurizing fluids (320) in accordance with embodiments of the present invention may occur while fluids (320) exit a fluid bag or may occur through a combination of steps before and while fluid (320) exits a fluid bag (308). As described herein below, pressurizing systems, such as ratcheting systems, stepper device motors, springs, and other pressurizing systems may pressurize fluids within a fluid bag. Accordingly, an apparatus of the present invention may secure and maintain pressure within a fluid bag.

Pressurizing fluid within a fluid bag may first begin with storing potential energy in a stretched spring. In another exemplary embodiment of the present invention, prior to a fluid bag being hung and secured to a holding device (302), the holding device (302) may be rotated, and the rotation creates torque. For example, a tension-creating device, such as a spring (not shown), for example, a spiral torsion spring, in communication with the holding device (302) may be stretched as the holding device (302) rotates within an apparatus of the present invention. The spring may absorb energy to create resistance to the force associated with the stretching of the spring as the holding device rotates. In an embodiment, when a user secures the fluid bag on the tensioned holding device, for example, the tension, that is, the potential energy stored in the spring, may be released and may be converted into pressure within the secured fluid bag. In this way, an apparatus of the present invention is wound up as part of routine emergency preparedness before a patient may need fluid. That is, potential energy may be stored in a spring until the patient may need fluids. To that end, the fluids from the secured fluid bag may be delivered without human interaction or winding of the holding device (302), as the spring held the potential energy, pre-use. Accordingly, a spring in communication with a holding device may store potential energy prior to securing a fluid bag and may release the potential energy to pressurize fluids within a secured fluid bag.

A pressurizing system may comprise a motor device, such as a stepper device motor, with, for example, an electronic control system responsive to torque measured on the holding device or pressure measured within the fluid bag. In an alternative, a pressurizing system may, for example, comprise a ratcheting system with a hand-held knob. In an embodiment, the shape of the knob may allow a user to create torque on the holding device and increase pressure within a fluid bag manually. FIG. 4 illustrates a top-front perspective view of an exemplary embodiment of ratcheting system (400) in accordance with the present disclosure. In an embodiment, for example, a holding device (402) may comprise a cylindrical body, such as a cross bar. The holding device (402) may further comprise a first knob (436), which may communicate with, for example, a first ratchet wheel (404). The holding device (402) may further comprise a second knob (446), which may communicate with, for example, a second ratchet wheel (414). In an embodiment, for example, a holding device (402) may further comprise the first ratchet wheel (404) at a first end (412) and the second ratchet wheel (414) at a second end (416). In an exemplary embodiment, a back face (432) of the fluid bag (406) may be in communication with an exterior surface (434) of the holding device (402). The fluid bag (406) may comprise a ruler (426) identifying a volume of fluid (420) in the fluid bag (406) on a front face (438) of the fluid bag (406). Accordingly, a holding device of the present invention may secure a fluid bag.

In an embodiment, for example, a medical professional may manually rotate, at least, a first ratchet wheel (404) clockwise, using, for example, the first knob (436), thereby, rolling up a fluid bag (406) secured to the holding device (402). In an embodiment, the fluid bag (406) may be secured to the holding device (402) via, for example, a fluid bag securing device (424), such as a clipping mechanism, such as a hook, in communication with a hole (430) in the fluid bag (406). To ease rotation of the holding device (402) and the fluid bag (406), a top of the fluid bag (406) secured to the holding device (402) via the fluid bag securing device (424) may communicate with a cavity (440) within the holding device (402). In an alternative embodiment, a first ratchet wheel (404) may rotate counterclockwise. Indeed, a ratcheting system (400) of the present invention may function ambidextrously, such that the holding device (402) may rotate clockwise or counterclockwise. Accordingly, a user may control holding device rotation.

To control the rotation, the first ratchet wheel (404) may communicate with a first pawl (408) secured on a rod (410). In an embodiment, for example, a first ratchet wheel (404) may communicate with a first pawl (408) positioned at a first end (409) of a rod (410), and a second ratchet wheel (414) may communicate with a second pawl (418) positioned at a second end (422) of the rod (410). In an exemplary embodiment, by engaging at least the first pawl (408), the ratcheting system (400) of the present invention may prevent the first ratchet wheel (404) from moving in a backward or counterclockwise rotation. In another embodiment of the present invention, a motor device may replace the ratchet wheel (404), first knob (436), and pawl mechanism (408). It should be noted that controlling the rotation, as described herein, may also help a user create stable and continuous pressure within the fluid bag (406) when the fluid is not being delivered. Accordingly, an intravascular fluid bag pressurizing apparatus of the present invention may use a ratchet system to prevent unraveling of a secured, rolled-up fluid bag.

In an embodiment, as a user turns, for example, the first knob (436) pressure may increase within the fluid bag (406). As fluid (420) leaves the fluid bag (406), pressure within the fluid bag (406) may decrease. In an embodiment, a ratcheting system (400) of the present invention may comprise a spring system. For example, rather than a user rotating, for example, a first knob (436), again, to further rotate a holding device (402), and re-pressurize the fluid bag (406), a spring (not shown) may communicate with at least the first ratchet wheel (404). The spring (not shown) may wind the holding device (402), as pressure in the fluid bag (202) decreases, as tension builds up within the spring (not shown), tension may be transferred to the holding device and may reduce the number of times a user must rewind the holding device. Accordingly, a spring may absorb potential energy during rotating of a holding device and rolling up of a fluid bag.

In an exemplary embodiment, a ratcheting system (400) may further comprise a quick-release device. For example, a fluid bag (406) may empty; however, the ratcheting system (400) may keep the fluid bag (406) rolled up on and conformed to the holding device (402). Release of the ratcheting system (400) may allow for backward rotation of the fluid bag (406). Deliberate, backward rotation of the fluid bag (406) may unroll the fluid bag (406) until the fluid bag securing device (424) appears. A user may release, for example, the fluid bag (406) from the fluid bag securing device (424) to replace the fluid bag (406). For example, in an embodiment, a medical professional may separate a first pawl (408) from a first ratchet wheel (404). To that end, a combination of a weight of the fluid bag (406) and tension on the first ratchet wheel (404) may unroll a rolled-up fluid bag (406) while rotating a holding device (402) in a counter-clockwise direction. Accordingly, an apparatus of the present invention may comprise a release device to release a wound fluid bag from a holding device.

In an exemplary embodiment, a quick release lever may quickly unwind or a motor may automatically begin the unwinding process. In an embodiment, for example, a motorized ratcheting system (400) of the present invention may sense when a fluid bag (406) is empty and may reverse the motor direction to unwind the fluid bag (406). In this way, a ratcheting system (400) of the present invention may return a fluid bag (406) to its starting position. In doing so, in an exemplary embodiment, the fluid bag securing device (424) may appear easily accessible, so that the empty fluid bag (406) may be easily replaced with a new fluid bag that is full. In an embodiment, for example, the motorized movement of a ratcheting system (400) of the present invention may be controlled with buttons that pressurize and depressurize the fluid bag (406), or, for example, by sensing pressure within the fluid bag (406). Accordingly, an intravascular fluid bag pressurizing apparatus of the present invention may leverage a ratcheting system to support efficient replacement of fluid bags.

In an alternative embodiment, an electrical device, for example, a motor device, may rotate, at least, the first ratchet wheel (404). In an embodiment, for example, a ratcheting system (400) of the present invention may comprise a stepper drive motor. For example, an embodiment of the present invention may comprise buttons in communication with the stepper drive motor to unwind and wind the holding device (402). In this way, activating wind buttons may rotate the holding device (402), roll up the fluid bag (406), and pressurize fluids in the fluid bag (406). Activating an unwind button may prepare the apparatus of the present invention to re-pressurizing the fluid bag (406). Accordingly, a stepper drive motor may control rotation of a holding device.

A stepper drive motor may deliver controlled torque to a rotating holding device (402), which pulls up the fluid bag (406) around the holding device (402). In an exemplary embodiment, the stepper drive motor may rotate a holding device (402) at planned increments, such as continuous, infinitesimal rotations to avoid blood clotting in infusion tubing or in a patient. Alternatively, as described in FIG. 3, a ratcheting system (400) or a stepper drive motor, or combination thereof, may respond to a signal from a pressure sensor device. For example, in an embodiment, a stepper drive motor may rotate a holding device (402) on a programed, step-by-step basis to maintain a set pressure in a fluid bag (406). Further, the stepper drive motor in combination with a ratcheting system (400) of the present invention may offer safety measures. In an embodiment, a stepper drive motor may be positioned at one end of the holding device (402) and a first knob (436) may be positioned at an opposite end of the holding device (402). Should power to the stepper drive motor be cut, a user may continue to use the apparatus of the present invention by manually engaging with a ratcheting system (400) via at least a first knob (436). Accordingly, a stepper drive motor may rotate a holding device of the present invention.

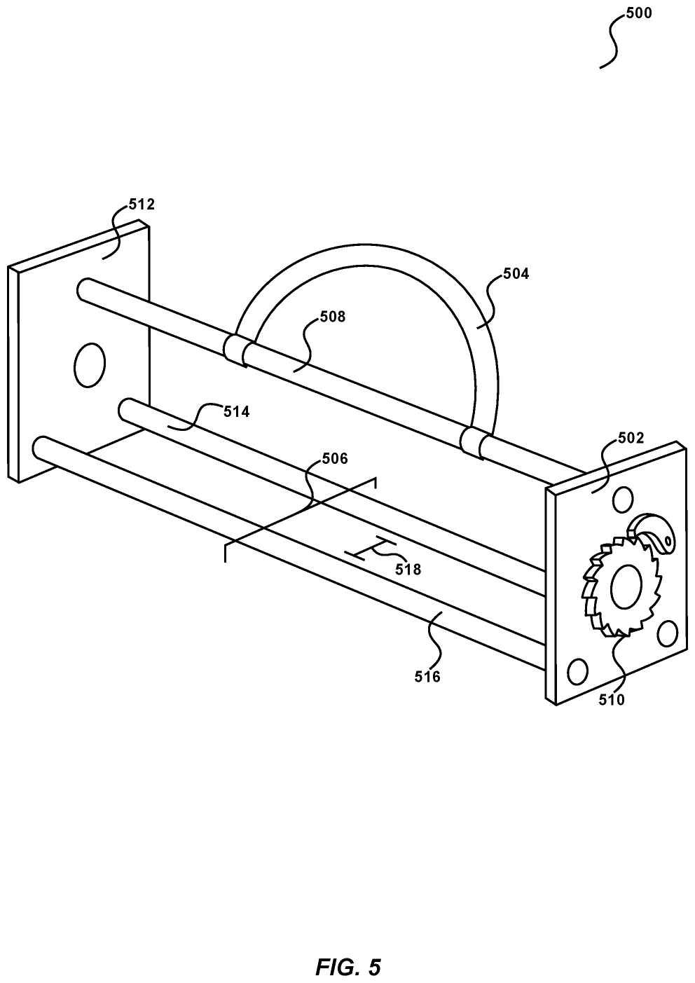

In an exemplary embodiment of the present invention, a suspended intravascular fluid bag pressurizing apparatus of the present invention may comprise a device to suspend a fluid bag while employing the devices described herein above in FIGS. 2-4. FIG. 5 illustrates a top-front perspective view of an exemplary embodiment of an apparatus housing (500) in accordance with the present disclosure. In an exemplary embodiment, an apparatus housing (500) may comprise a housing (502) and a fluid bag entry (506). In a suspended embodiment of the present invention, an apparatus housing (500) may further comprise a hanging device (504). The hanging device (504) may comprise a hooking device, such as a hook or loop, which may be attached at a top element (508) of the housing (502). A top element (508) may, for example, comprise a top surface or a bar spanning between a first side (510) of the housing (502) substantially parallel and opposite to a second side (512) of the housing (502). Accordingly, an intravascular fluid bag pressurizing apparatus of the present invention may comprise a housing to secure a fluid bag.

In an exemplary embodiment, the fluid bag entry (506) may comprise a first guide (514) and a second guide (516) positioned below the top element (508). In an embodiment, for example, each of the first guide (514) and second guide (516) may be secured to the housing (502) at the first side (510) and second side (512). The first guide (514) and second guide (516) of the present invention may facilitate fluid bag positioning on a fluid bag securing device and a holding device. In an exemplary embodiment, an apparatus housing (500) of the present invention may further comprise a distance (518) between the first guide (514) and the second guide (516). In an exemplary embodiment, the first guide (514) and the second guide (516) may be adjustable to allow for accommodating changes in distance (518). For example, in an embodiment, the distance (518) of the present invention may work for a variety of volumes of IV fluid bags. In an embodiment, an apparatus housing (500) of the present invention may accommodate 200 cubic centimeters, 1 liter, or other volumes of IV fluid bags. In an exemplary embodiment, the distance (518) may be sufficiently wide to permit a fluid bag to pass between the first guide (514) and second guide (516) and may be sufficiently narrow to communicate with the fluid bag as it may roll up. In doing so, in a suspended embodiment of the present invention, a combination of the first guide (514), second guide (516) and distance (518) may maintain a substantially vertical orientation of the fluid bag while the fluid bag may roll up. In an embodiment, the positioning of the first guide (514) may be more forward from a holding device (402), as described in FIG. 4, than a second guide (516) may be backward from the holding device (402). Accordingly, an intravascular fluid bag pressurizing apparatus of the present invention may comprise a positioning guide structure for the fluid bag.

As described in FIG. 4, an intravascular fluid bag pressurizing apparatus of the present invention may comprise a ratcheting system (400). A first ratchet wheel (404) may communicate with a holding device (402), which may form a shaft of the ratcheting system (400). The ratcheting system (400) may also comprise a first pawl (408), which may halt backward movement of the first ratchet wheel (404). In an exemplary embodiment of an apparatus housing (500) of the present invention, the first pawl (408) may communicate with a top element (508), such as a bar, which may secure the first pawl (408) to the apparatus housing (500). Accordingly, fluid within a guided and secured fluid bag may be pressurized using, at least, a ratcheting system of the present invention.

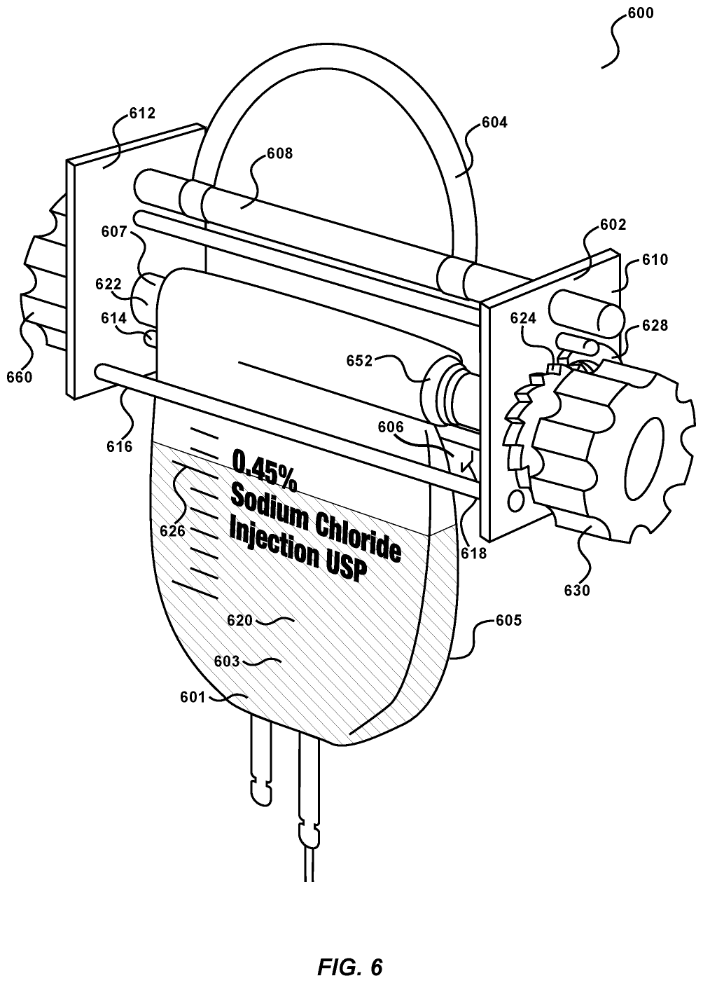

FIG. 6 illustrates a top-front perspective view of an exemplary embodiment of a deployed apparatus housing (600) in accordance with the present disclosure. In an embodiment, for example, of an apparatus housing (600) may secure a fluid bag (601) comprising a volume of fluid (620), as measured by a ruler (626) on a front face (603) of the fluid bag (601). In an embodiment, for example, a back face (605) of the fluid bag (601) may communicate with a top surface (607) of a holding device (622). In an exemplary embodiment, a deployed apparatus housing (600) may comprise, as described in FIG. 5, a housing (602) and a fluid bag entry (606). In a suspended embodiment, a deployed apparatus housing (600) may further comprise a hanging device (604). In an exemplary embodiment, the hanging device (604) may comprise a hooking device, such as a hook or loop, which may be attached at a top element (608) of the housing (602). A top element (608) may, for example, comprise a first side (610) of the housing (602) substantially parallel and opposite to a second side (612) of the housing (602). In an exemplary embodiment, the fluid bag entry (606) may comprise a first guide (614) and a second guide (616) positioned below the top element (608). In an embodiment, for example, each of the first guide (614) and second guide (616) may be secured to the housing (602) at the first side (610) and second side (612). In an exemplary embodiment, a deployed apparatus housing (600) of the present invention may further comprise a distance (618) between the first guide (614) and the second guide (616). Accordingly, a deployed apparatus housing of the present invention may include structural support elements.

In an embodiment, at least the first guide (614) or the second guide (616) may be coated in a slippery material, or other low friction coating to facilitate movement of the fluid bag (601). In an embodiment, for example, a distance (618) may comprise about approximately 0.5 centimeter to 6 centimeters. In an embodiment, the distance is adjustable, which may allow a deployed apparatus housing (600) of the present invention to add more pressure to the fluid bag (601). Accordingly, a first guide and a second guide may support pressurizing fluids within a fluid bag.

An exemplary embodiment of a deployed apparatus housing (600) of the present invention may further comprise, as described in FIG. 4, a first ratchet wheel (624), which may communicate with a holding device (622), which may form a shaft of a ratcheting system (400). An example of a deployed apparatus housing (600) of the present invention may further comprise a first pawl (628), which may halt backward or counterclockwise movement of the first ratchet wheel (624). In an embodiment, a deployed apparatus housing (600) may comprise a release device, which, when engaged, may separate the first pawl (628) from the first ratchet wheel (624). An exemplary embodiment of a deployed apparatus housing (600) may, as described in FIG. 3, secure the fluid bag (601) and wrap the fluid bag (601) around the holding device (622), and, as the holding device (622) may rotate, layers (652) of the fluid bag (601) may roll up around the holding device (622). Accordingly, a deployed apparatus housing of the present invention may roll up a fluid bag.

In an embodiment, an apparatus housing (600) of the present invention may comprise a first knob (630). An apparatus housing (600) of the present invention may also comprise a second knob (660) positioned at an opposite end of a holding device (622) from the first knob (630). In an embodiment, the first knob (630) and the second knob (660) may be noticeably larger than the holding device (622). For example, in an embodiment, the holding device (622) may be approximately between 1 centimeter and 3 centimeters in diameter and, for example, the first knob (630) may be approximately two inches to three inches in diameter, which may allow the first knob (630) to fit into the palm of a user's hand. In this way, a user may grip the first knob (630), In an embodiment, the first knob (630) may comprise tactile material, such as rubber grip. For example, a user may grip the first knob (630) and may quickly and efficiently rotate the holding device (622), roll up the fluid bag (601), and pressurize the fluid bag (601) using hand strength. For example, in an embodiment, an apparatus of the present invention may pressurize fluids within a fluid bag (601) in a few “click” or slight turns of the first knob (630) to over, for example, 200-300 mmHg. A user may not have the ability to over pressurize the fluids. In this way, an apparatus of the present invention may maintain pressure ranges that are safe and within published regulatory safety protocols. Accordingly, a knob configuration may ease pressurizing fluids within a fluid bag without enabling unsafe operations.

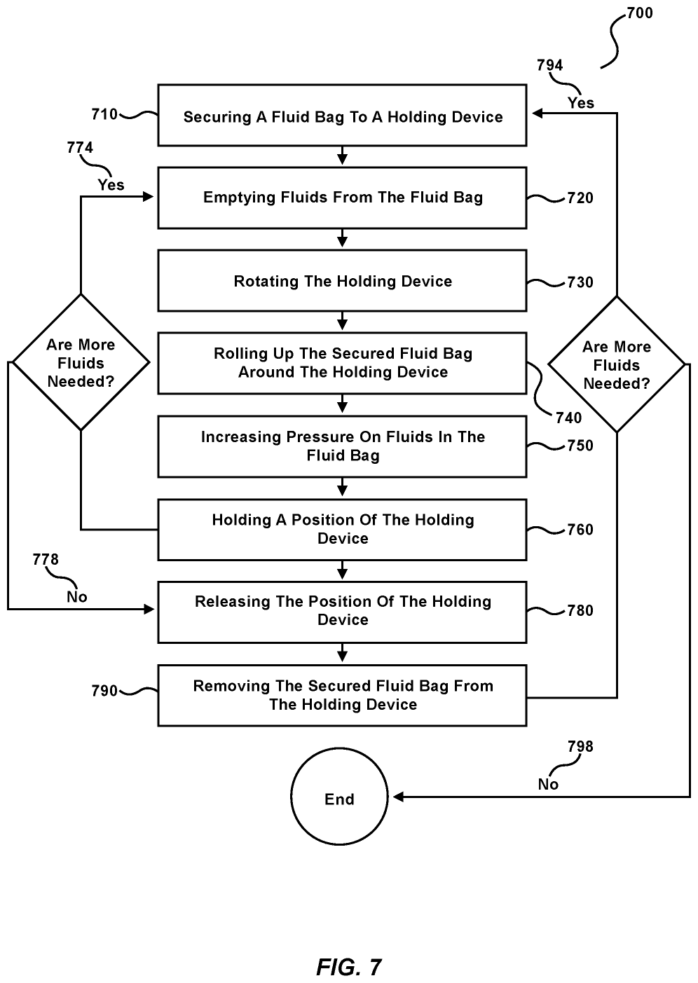

FIG. 7 illustrates a flow diagram showing pressurizing a fluid bag (700) in accordance with the present disclosure. A method of the present invention may comprise securing a fluid bag to a holding device (710) and emptying fluid from the fluid bag (720). In an embodiment, fluid may be initially released from the fluid bag at normal rates, that is, unpressurized. In an alternative embodiment, pressurizing a fluid bag (700) may comprise maintaining at least some fluid in a fluid bag when deployed for inside artery application. The method may further comprise rotating the holding device (730), rolling up the secured fluid bag around the holding device (740), and increasing pressure on the fluids in the fluid bag (750). The method may further comprise holding a position of the holding bag (760). If more fluid is needed (774), the method of the present invention may comprise emptying fluids from the fluid bag (720). If no more fluid is needed (778) the method of the present invention may further comprise releasing the position of the holding device (780). The method of the present invention may further comprise removing the secured fluid bag from the holding device (790). If more fluid is needed (794), the method of the present invention may comprise securing a fluid bag to a holding device (710). If no more fluid is needed (798) the method of the present invention may end.

As described herein above, another method of pressurizing fluid within a fluid bag in accordance with the present disclosures begins before step (710), that is, securing a fluid bag to a holding device (710). For example, in an embodiment, pressurizing fluids within a fluid bag may comprise rotating an empty holding device in communication with a tension-creating device to a first position. The tension-creating device may comprise, for example, a spiral torsion spring. As the holding device rotates, the spiral torsion spring may stretch. In an embodiment, pressurizing fluids within a fluid bag may further comprise the tension-creating device absorbing energy from the rotating the holding device to the first position. For example, as the spiral torsion spring stretches with the rotation of the holding device, the spiral torsion spring may absorb potential energy. In an embodiment, a fluid bag may be secured to the holding device once the tension-creating device reaches a tensioned, stretched state. In this position, the holding device may be acting under tension while securing the fluid bag. Accordingly, a method of the present invention may comprise securing a fluid bag to a holding device in a tense position.

Pressurizing fluids within a fluid bag may further comprise releasing the tension-creating device. The potential energy stored within the tension-creating device may be used to rotate the holding device and pressurize fluids within the fluid bag. That is, pressurizing fluids within a fluid bag may further comprise rotating the holding device to a second position and pressurizing fluids within a fluid bag. The rotating of the fluid bag may be controlled by controlling the amount of release of the tension-creating device. That is, a release device may control the converting of tension from the tension-creating device to energy to rotate the holding device. For example, a spiral torsion spring may be released in increments to maintain pressure on fluids within a fluid bag as fluids exit the fluid bag. The potential energy stored within the tension-creating device may function to rotate the holding device until all potential energy has been released from the tension-creating device. For example, once a spiral torsion spring is released to an unstretched state, the spiral torsion spring may no longer transfer potential energy to rotate the holding device. In an embodiment, as the tension-creating device reaches a final, steady, unstretched state, the holding device may no longer rotate. In an embodiment, if fluid remains in a fluid bag, a user may, for example, rotate a knob, as described herein above in FIGS. 4 and 6, in communication with a holding device to rotate the holding device (730), as described in FIG. 7. Accordingly, pressurizing a fluid bag may comprise releasing energy from a tension-creating device to rotate a holding device.

It is to be understood that the various embodiments shown and described herein are to be taken as exemplary. Elements and materials, and arrangements of those elements and materials, may be substituted for those illustrated and described herein, parts may be reversed, and certain features of the present disclosure may be utilized independently, as would be apparent to one skilled in the art after having the benefit of the description herein. Changes may be made in the elements described herein without departing from the spirit and scope of the present disclosure and following claims, including their equivalents.

It is to be understood that the particular embodiments set forth herein are non-limiting, and modifications to structure, dimensions, materials, and methodologies may be made without departing from the scope of the present disclosure.

It is to be further understood that this description's terminology is not intended to limit the invention. For example, spatially relative terms, such as “front,” “back,” “top,” “bottom,” “side,” and the like, may be used to describe one element's or feature's relationship to another element or feature as intended to connote the orientation of, for example, the suspended intravascular fluid bag pressurizing apparatus as illustrated in the figures.

For the purposes of this specification and appended claims, unless otherwise indicated, all numbers expressing quantities, percentages or proportions, and other numerical values used in the specification and claims, are to be understood as being modified in all instances by the term “about” if they are not already. That is, unless indicated to the contrary, the numerical parameters set forth in the specification and claims are approximations that may vary depending on the desired properties sought to be obtained by the present disclosure.

1. An apparatus, comprising:
a fluid bag holding device in communication with a fluid bag securing device;
an adjustable fluid bag guiding device;
a pressurizing device in communication with the fluid bag holding device; and
a holding device release device.

2. The apparatus of claim 1, further comprising:
the holding device release device responsive to a fluid bag pressure sensing device measurement, the measurement further comprising a fluid pressure in a fluid bag.

3. (canceled)

4. The apparatus of claim 1, wherein the pressurizing device comprises a stepper drive motor.

5. The apparatus of claim 1, wherein the pressurizing device comprises a ratcheting system.

6. The apparatus of claim 1, further comprising:
at least one knob.

7. The apparatus of claim 6, further comprising:
the at least one knob comprising a handgrip.

8. The apparatus of claim 1, further comprising:
a haptic feedback mechanism.

9. The apparatus of claim 1, further comprising:
an auditory feedback mechanism.

10. A method, comprising:
securing a fluid bag to a holding device in the first position;
rolling the secured fluid bag around the holding device to a second position;
increasing pressure on fluids in the fluid bag at the second position;
delivering fluids from the secured fluid bag;
releasing the holding device from the second position; and
releasing the secured fluid bag from the holding device.

11. The method of claim 10 further comprising:
flattening the secured fluid bag and generating pressure from within the secured fluid bag.

12. The method of claim 10 further comprising:
maintaining a shape of the fluid bag.

13. The method of claim 10 further comprising:
maintaining visibility of fluid volume within the fluid bag.

14. The method of claim 10 further comprising:
sensing fluid pressure within the fluid bag and rolling the secured fluid bag around the holding device to the second position responsive to the sensed fluid pressure.

15. A method, comprising:
rotating an empty holding device in communication with a tension-creating device to a first position;
the tension-creating device absorbing energy from rotating the empty holding device to the first position;
securing a fluid bag to the holding device in the first position;
releasing the tension-creating device;
rotating the holding device to a second position with energy from the released tension-creating device; and
delivering pressurized fluids from the secured fluid bag.

16. The method of claim 15, further comprising:
maintaining pressure on fluids within the secured fluid bag while releasing energy from the tension-creating device.
